(19) United States
(12) Patent Application Publication
(10) Pub. No.: US 2015/0244727 A1
(43) Pub. Date: Aug. 27, 2015

(54) METHOD FOR AUTHENTICATING A SECURITY ELEMENT BY SUPERIMPOSING N SHARED COLOUR IMAGES, AND SECURITY ELEMENT IMPLEMENTING SAID METHOD

(71) Applicants: Thierry FOURNEL, Saint-Galmier (FR); Pierre-Jean ARNAUD, Rive de Gier (FR); Michel CAMUS, Rives (FR); Christophe HALOPE, Rochegade (FR); Jacques MACHIZAUD, Saint-Etienne (FR); ARJOWIGGINS SECURITY, Boulogne Billancourt (FR); CENTRE NATIONAL DE LA RECHERCHE SCIENTIFIQUE, Paris (FR); UNIVERSITE JEAN MONNET, SAINT-E-TIENNE, Saint Etienne cedex 2 (FR)

(72) Inventors: Thierry Fournel, Saint-Galmier (FR); Michel Camus, Rives (FR); Christophe Halope, Rochegade (FR); Mathieu Hebert, Lyon (FR); Jacques MacHizaud, Saint-Etienne (FR)

(73) Assignees: ARJOWIGGINS SECURITY, Boulogne Billancourt (FR); UNIVERSITE JEAN MONNET, SAINT-E-TIENNE, Saint Etienne cedex 2 (FR); CENTRE NATIONAL DE LA RECHERCHE SCIENTIFIQUE, Paris (FR)

(21) Appl. No.: 14/427,211

(22) PCT Filed: Sep. 11, 2013
(86) PCT No.: PCT/FR2013/052087

§ 371 Date: Mar. 10, 2015

(30) Foreign Application Priority Data
Sep. 11, 2012 (FR) 1258535

(51) Int. Cl. H04L 29/06; B42D 25/328; H04N 1/405; H04L 9/08; H04N 1/60

(52) U.S. Cl. CPC H04L 63/123; H04L 9/088; H04N 1/60; H04N 1/40018; H04N 1/6097; B42D 25/328; H04L 2209/046

(57) ABSTRACT

A method for authenticating a security element by superimposing N shared colour images in order to obtain at least one target colour may include a phase of constructing an authenticator system that includes a step of selecting a target colour; a step of selecting a series of N decomposition colours which, by means of superimposition, together enable the target colour to be obtained; and a step of recording the N shared images each with a decomposition colour from the series. A security element comprising at least one shared image may be obtained according to the method.

The invention relates to the technical field of information transmission in a form making it possible to ensure, on the one hand, confidentiality thereof during transmission and, on the other hand, authentication of the sender. In a preferred but non-exclusive application, the invention relates to the field of the authentication of products, of security documents and of diverse objects so as, in particular, to allow a user or recipient to verify the origin and/or the authenticity thereof, by a visual check in particular.

In the field of product authentication, an application WO2005/091 232 has proposed to use a message known to the recipient alone and an image of the product and then to generate on the basis of this message and of the background image according to a method of visual cryptography such as described by U.S. Pat. No. 5,488,664 two images, one of which is printed on a label associated with the product, the other being communicated to the recipient of the product. After having received the product with its associated label, the user can, by superimposing the image which has been communicated to him and the printed image, read the message known to him alone thereby guaranteeing him the authenticity of the product insofar as, if he cannot see the message, he can deduce therefrom that forgery has taken place.

Such a system makes it possible to guarantee to the recipient that the product that he has received was indeed intended for him and that it has been manufactured or addressed by an authorized entity in possession of his secret message. However, this system requires customization of each label as a function of the recipient of the product and, therefore, is not suitable for mass production occurring well before the product is sold or ordered by an end user.

An international application WO2004/063 993 has also proposed to implement a message enciphered according to techniques of visual cryptography and incorporated into a background image for the authentication of a commercial instrument such as a transport ticket or show ticket purchased on an online sales service and printed locally by the purchaser. Like application WO2005/091 232, international application WO 2004/063 993 proposes to implement a second image making it possible by superimposition with the background image incorporating the enciphered message to reveal the enciphered message so as to be assured of the authenticity of the constituent information of the ticket. Such a method actually allows authentication of the information associated with a ticket within the framework of a partly dematerialized transaction but does not allow authentication of a product possibly associated with this ticket.

Such methods make it possible to produce systems for authentication by visual cryptography which exhibit the drawback of being in black and white and which are therefore rather unesthetic. Moreover, these black and white systems are relatively easy to reproduce or to duplicate.

Some publications have proposed to extend the principles of black and white visual cryptography to color systems which exhibit the drawback of not allowing the use of varied colors and some of which require the printing of black masks on some shared images, which is detrimental to their esthetics and does not strengthen the security of the product so as to avoid malicious reproduction.

The need is therefore apparent for a novel method of authentication which allows the use of shared color images offering improved esthetics with respect to the systems according to the prior art as well as possibilities of more extensive modes of authentication than those of the prior art.

In order to achieve this objective, the invention relates to a method for authenticating a security element by superimposing N shared color images so as to obtain at least one target color, said method comprising a phase of constructing an authenticator system comprising at least:
a step of selecting a target color,
a step of selecting a series of N decomposition colors which, by superimposition, together make it possible to obtain the target color,
a step of recording the N shared images, each with a decomposition color of the series.

Thus, each shared image, taken in isolation, not making it possible to ascertain the target color, only the possession of the whole set of shared images makes it possible by superimposition to produce the target color which, known to the verifier or to the verifier system, makes it possible to check the authenticity of the security element. In this case, the protected information is the target color.

Within the meaning of the invention, the security element can be of diverse kinds such as a commercial object, a product for consumption, a packaging, an official document, a tax document, an identity document or else a label attached to an object without this list being limiting or exhaustive.

Likewise, within the meaning of the invention, the phrase series of N decomposition colors should be understood in the sense of a group of N colors which, by superimposition, make it possible to obtain the target color and which are not necessarily different from one another.

According to one form of implementation of the invention, the construction phase comprises:
a step of selecting at least one pattern cut up into a finite number of zones, where “pattern” signifies a region, connected or not, lying within the security element, a step of selecting a target color per zone,
a step of selecting for each target color a set of M series of N decomposition colors, the decomposition colors of each series making it possible, by superimposition, together to obtain said target color,
a step of constructing N shared images, each one reproducing each pattern, the construction step involving for each zone of a pattern:
   the choosing of a decomposition series from the selected set,
   the assigning to said zone and for each shared image of a decomposition color of the chosen series,
a step of recording the N shared images.

Within the framework of this form of implementation of the invention it is not the pattern which is the authenticating element but the target color in each zone of the pattern.

Within the meaning of the invention a pattern can, for example, be a visually recognizable symbol, an alphanumeric inscription or a code, a geometric shape, a writing symbol, an image of a recognizable object, in particular a logo, a plant, an animal or a personage, a banknote denomination without this list being either limiting or exhaustive.

According to a variant of this form of implementation, the choosing of the decomposition series is performed in a random or pseudo-random manner from the selected set of M series of N decomposition colors.

According to a characteristic of the invention, each decomposition color of the series associated with a target color is used, for a given zone, on a single shared image.

According to another form of implementation of the invention, the phase of constructing the authenticator system comprises:
a step of selecting a secret image which comprises at least one pattern and a region complementary to the pattern, each cut up into a finite number of zones,
a step of selecting a target color associated with each zone,
a step of selecting, for each target color, a set of M series of N decomposition colors, the decomposition colors of each series making it possible, by superimposition, together to obtain the target color and M being greater than or equal to 2,
a step of constructing N shared images such that:
   for each zone of each pattern, a series of decomposition colors is chosen from the selected set of M series of N decomposition colors for the target color of said zone, the decomposition color of rank k in said series is assigned to the zone in the shared image of rank k in the superimposition of the N shared images,
   for each zone of the complementary region, a decomposition color of rank k is chosen from among the decomposition colors of like rank in the selected set of M series of decomposition colors,
a step of recording the N shared images.

Within the framework of this other form of implementation, the authentication results from the combination of the viewing of the target color associated with each zone and of the secret image.

According to a variant of this embodiment, in each zone of the complementary region, a decomposition color of rank k is chosen from among the decomposition colors of like rank in the selected set of M series of N decomposition colors so that the N decomposition colors chosen do not together give, by superimposition, the target color.

According to another variant of this embodiment, the secret image is visible in transmitted light and is not visible in reflected light.

According to another variant of this embodiment the selections of secret image or of target color or of series of decomposition colors of the target color are performed in a random or pseudo-random manner.

According to yet another variant of this embodiment the choices of the N decomposition colors for a complementary region zone and/or of the series of N decomposition colors for a pattern zone are performed in a random or pseudo-random manner. A random choice such as this makes it possible to limit or indeed to cancel the risks of leakage of the secret image at the level of each shared image. Within the meaning of the invention, the random choice or the allotting of the series of N colors can be carried out in any appropriate way by means of random sequences. Thus, electronic generators of random sequences can be used. According to a variant of the invention, each random choice is performed by means of at least one random sequence, the so-called brand signature, which is extracted or generated on the basis of at least one structural characteristic of a region at least of the security element and is able to be generated or extracted on demand and obtained identically or quasi-identically on the basis of the security element.

This variant of the invention makes it possible to create a one-to-one tie between the secret image and the security element by implementation of the brand signature for the construction of the shared images.

According to a variant of the invention, several brand signatures can be extracted or generated apart from that extracted from the security element, respectively of any material support to be protected by the security element or of any other security element present on this material support or on the security element considered, by creating a random sequence resulting from the concatenation or the random permutation of the bits (or digits) of the extracted brand signatures.

Within the meaning of the invention, the phrase random sequence should be understood in the sense of a sequence of numbers which are the independent realization of a uniformly distributed, that is to say equiprobable, variable. Among the random sequences usable within the framework of the invention may be cited binary random sequences consisting of a series of mutually independent equidistributed binary values. A random sequence generated by means of a structural characteristic of an element or security element as described in FR 2 870 376 or FR 2 895 543, which are incorporated here by reference, corresponds to the definition of random sequence within the meaning of the invention.

Within the meaning of the invention, the fact that the random sequence used, the so-called brand signature, can be generated on demand and identically or quasi-identically on the basis of the security element corresponds to the fact that this brand signature is stable while being random. A stable random signature extracted from a structural characteristic of a material element, as described by FR 2 895 543, is a brand signature, within the meaning of the invention, which can be recalculated or regenerated by a new implementation of the algorithm used on one and the same region of the element or security element. During the construction of the authenticator system and whenever necessary, the brand signature is generated or extracted by reading the material element via a brand signature extraction device. Owing to the random nature of the brand signature, each value of brand signature is different from one material element to another or from one family of material elements to another and each signature value may not be predicted even in the presence of the element or security element except, of course, by knowing the algorithm implemented and, in the case of the algorithm described by FR 2 895 543, the decomposition basis used and/or the brand signature extraction parameters such as the shape of the acquisition window and/or its direction of reading. In the latter case, the decomposition basis and/or the extraction parameters can each be considered to be a secret key for the extraction of the brand signature.

At each extraction the brand signature is identical or quasi-identical to that used during the construction of the authenticator system. Quasi-identical signifies that there exists a small variation or difference between the brand signatures extracted from one and the same region of one and the same security element.

Likewise within the meaning of the invention, the structural characteristic can be a characteristic peculiar to the security element in the guise of an individual security element or in the case of an object arising from an industrial process aimed at producing a family of material objects having common structural characteristics, the structural characteristic can be a structural characteristic of the family. Among these industrial processes may be cited methods for molding or for stamping raw materials to obtain shaped workpieces or ones with a relief. It is also possible to cite industrial processes which consist in assembling various workpieces to obtain identical-looking manufactured objects or functional assemblies.

In order to limit the risks of leakage of the secret image and according to a variant of the invention, the shape and the size of the cut zones of the pattern and of its complementary region are chosen in such a way that a zone of the pattern and a zone of the complementary region are undifferentiable or indistinguishable.

Within the meaning of the invention, recording should be understood in the sense in particular of:
a recording in a printed or analogous form,
a recording in an analog form such as, for example, in a continuous tones printed form,
a recording in a nonelectronic or nonmagnetic digital form such as, for example, in a halftones printed form,
a recording in a digital, electronic, or magnetic form with computerized storage means, without this list being limiting or exhaustive.

Recording by printing can involve the depositing of inks or of substances making it possible to obtain optical properties of the printing support suitable for producing the shared images.

According to a characteristic of the invention, the decomposition colors are recorded as halftones.

According to another characteristic of the invention, the decomposition colors are selected so as together to obtain the target color in a predefined order of superimposition. In this regard, each decomposition color series is preferably an ordered series in which the rank of each decomposition color corresponds to the rank of the corresponding shared image in the superimposition of the shared images so as to obtain the target color. Moreover, within the framework of the implementation of supports printed on one face, the determination of each decomposition color series takes account of the position of the printed face of each support in the stack. The predefined order of stacking as well as the orientation of each of the supports in the stack can then be a secret and/or confidential item of information known solely to the user charged with undertaking verification of the authenticity of the security object by means of the shared images.

According to a further characteristic of the invention, the number M is equal to 2 or 3. The advantage of the implementation of 2 or 3 series for each target color makes it possible to limit the risks of leakages on the target color.

According to another characteristic of the invention, the number N is equal to 2 or 3. Such values of the number of shared images make it possible to facilitate registration or alignment of the superimposed shared images during a phase of verifying the authenticity of the shared object.

According to a characteristic of the invention, the phase of constructing the authenticator system comprises a step of recording at least one of the shared images in digital form.

According to a variant of the invention, the phase of constructing the authenticator system comprises a step of recording at least one of the shared images in printed form.

According to a characteristic of this variant, the phase of constructing an authenticator system comprises a step of printing at least one of the shared images on the security element.

According to another characteristic of this variant, at least one of the shared images is recorded by printing on a translucent support.

According to yet another characteristic of this variant, at least one of the shared images is recorded by printing on a transparent support.

According to another characteristic of this variant, all the shared images are recorded on a translucent support at least and in that according to the order of stacking of the shared images the color observed in reflection is different on the recto and on the verso of the stack.

According to another characteristic of this variant and when the shared images are intended to reveal a secret image, the secret image is visible in transmitted light and is not visible in reflected light.

According to another characteristic of this variant, at least one of the shared images is recorded by printing on an opaque support.

According to a characteristic of the invention, the phase of constructing an authenticator system comprises a step of recording in printed form at least one shared image and a step of recording at least one other shared image in digital form.

According to one form of implementation of the invention, the method of authentication can also comprise a phase of verification by a user comprising:
a step of superimposing at least part of the shared images so as to allow viewing of at least one target color and optionally of a secret image.

According to a variant of this form of implementation, the shared images are superimposed in a predefined order.

According to another variant of this form of implementation, at least one presentation step is performed by means of an electronic display or projection device.

According to yet another variant of this form of implementation, at least one presentation step is performed by means of at least one printed shared image.

The invention also relates to a method for verifying the authenticity of a security element bearing at least one first shared image constructed in accordance with the method of authentication according to the invention, the method of verification comprising the following steps:
implementation of the security element,
implementation of at least one other shared image,
superimposition of the shared images,
verification that the viewed target color and/or the viewed secret image corresponds to the target color and/or to the secret image expected so as in the affirmative to conclude the authenticity of the security element.

According to a characteristic of the invention the method of verification comprises a step of observation in reflected light of the recto and of the verso of the superimposition of the shared images and verification that the target color observed on the recto is different from the target color observed on the verso so as in the affirmative to conclude the authenticity of the security element.

According to another characteristic of the method of verification according to the invention the shared images are superimposed in a predefined order.

According to another characteristic of the method of verification, each support of a shared image is placed in a predefined sense in the stack. The phrase predefined sense should be understood as meaning the relative position of the recto or of the verso or else of the printed face of said support with respect to the other supports of the shared images in the stack.

The invention also relates to a security element which comprises at least one first shared image which is recorded in accordance with the method of authentication according to the invention and which is intended to allow the obtaining of at least one target color and/or of a secret image superimposed with at least one other shared image recorded in accordance with the method of authentication according to the invention.

According to a characteristic of the invention, the security element comprises at least two shared images recorded in accordance with the method of authentication according to the invention.

According to a variant of this characteristic, the security element is adapted for allowing the superimposition of the shared images that it bears. In this case the verification of the authenticity will be performed by superimposing the shared images borne by the security element.

According to a characteristic of the invention, the security element is a physical support comprising at least one semi-reflecting layer which covers all or part of at least one shared image and which has transparency and luminous reflection properties that vary according to the angle of observation (angle defined over the whole of the sphere).

According to a characteristic of the invention, each shared image of the security element is recorded as halftones.

The invention also relates to a security document including the security element according to the invention such as for example a passport, an identity card, a driver's license, an interactive playing or collecting card, a payment means, in particular a payment card, a banknote, a purchase slip or a voucher, a secure label, a transport card, a loyalty card, an entitlement card or a subscription card.

Of course, the various characteristics, variants and embodiments and forms of implementation of the method of authentication, of the method of verification and of the security element in accordance with the invention can be associated with one another according to diverse combinations insofar as they are not mutually incompatible or exclusive.

Moreover, diverse other characteristics of the invention emerge from the appended description given with reference to the drawings which illustrate nonlimiting forms of implementation of the methods and embodiments of the security element in accordance with the invention.

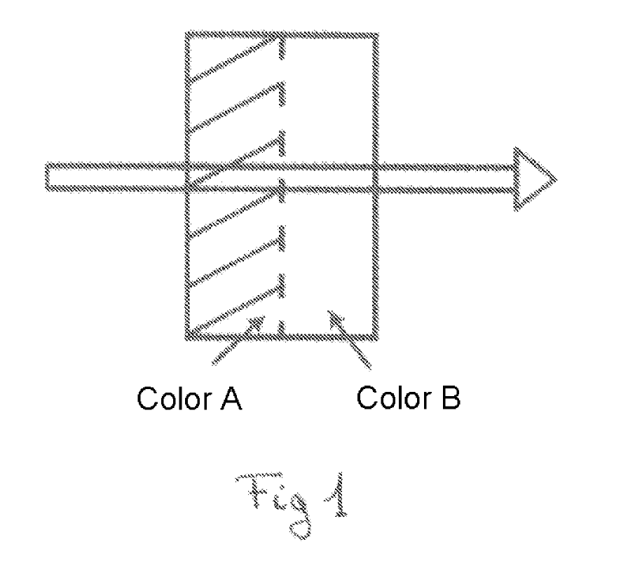

FIG. 1 illustrates the superimposition of two colors with no change of index at their interface.

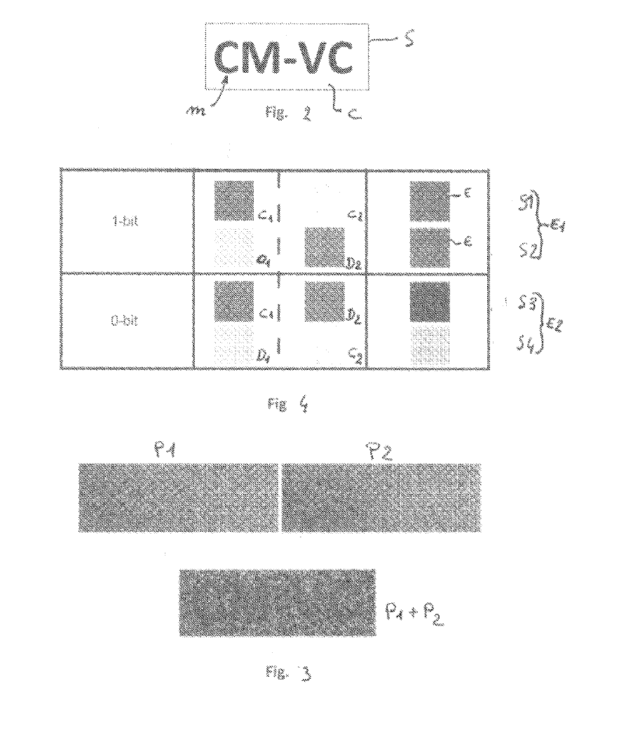

FIG. 2 is a secret image implemented for the construction of the shared images within the framework of a form of implementation of the method according to the invention.

FIG. 3 illustrates, on the one hand, two shared images, constructed on the basis of the secret image of FIG. 2 and, on the other hand, the result of the superimposition of these two shared images revealing the secret image.

FIG. 4 is an exemplary set of series of decomposition colors used for the construction of the shared images of FIG. 3.

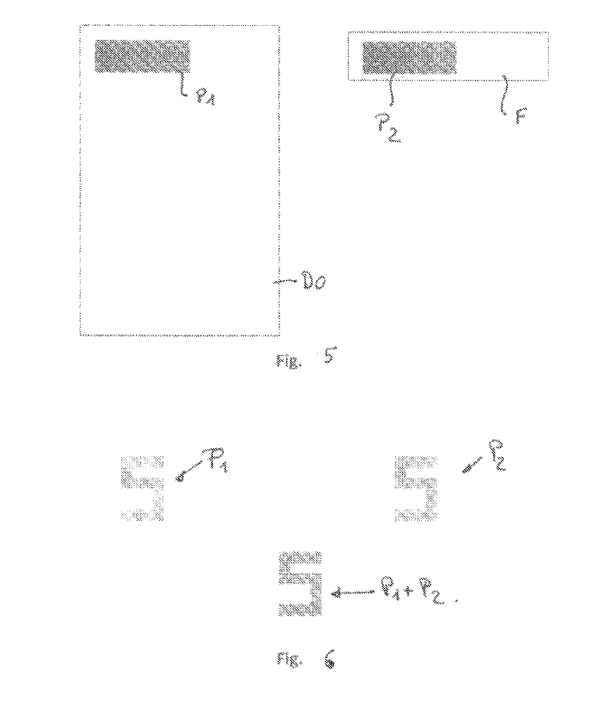

FIG. 5 illustrates an example of a security document implementing the shared images of FIG. 3.

FIG. 6 illustrates another form of implementation of the method according to the invention.

The principle of the invention resides on the correspondence of colors, namely the reproduction of one and the same target color through the superimposition of diverse combinations of decomposition colors. The precision of the color correspondence effect is generally optimal for predefined lighting and observation conditions. According to the invention, when for example two decomposition colors A and B are each printed on a transparency and superimposed one on the other, the target color obtained denoted φ(A,B) results from an operation of superimposing the colors where the operator φ is based on a predictive model of color rendition.

Firstly, when the superimposition involves two printed transparencies, observed from above with Lambertian lighting originating from below, the printed colors, which behave as spectral filters, can be described by their spectral transmittance. Initially, we assume that the transmittance of the superimposition is given by the product of the spectral transmittances of each color. In this case, φ is expressed as:

T_{φ(A,B)}(λ)=T_{A}(λ)T_{B}(λ) (1)

where T_{A}(λ) and T_{B}(λ) are the spectral transmittances of the transparency printed with the colors A and B, respectively, and T_{φ(A,B)}(λ) is the spectral transmittance of the color φ(A,B) obtained by superimposing the colors A and B.

This expression assumes that the two colors are superimposed with no change of index between their interfaces, as presented in FIG. 1. However, when the two transparencies are superimposed, a fine air layer is present between them thus creating two jumps in refractive index. In this case, the light passing through the first transparency will be partially reflected and transmitted by the second transparency according to the Fresnel coefficients. A process of multiple reflections between the two transparencies occurs. The superimposition of two printed transparencies is therefore more completely described by a model taking into account the process of multiple reflections. The operator φ can then be expressed as:

$${T}_{ϕ ( A , B )} ( λ ) = \frac{{T}_{A} ( λ ) {T}_{R} ( λ )}{1 - {R}_{A} ( λ ) {R}_{B} ( λ )} \qquad ( 2 )$$

where R_{A}(λ) and R_{B}(λ) are the spectral reflectances of the transparencies printed with the colors A and B respectively.

We may point out that equation (1) is the zero-order approximation of equation (2), which is valid in the case where the product R_{A}(λ)R_{B}(λ) is very small compared with 1. This approximation is valid in the case of two printed and superimposed transparencies when the amount of scattering by the support and/or the inks is low.

In the case where one of the supports is a Lambertian paper support, the observation is usually done in reflection at a given angle θobs and in diffuse lighting, the operator φ in this case being expressed as:

$${R}_{ϕ ( A , B )} ( λ ) = {R}_{A} ( λ ) + \frac{{T}_{A} ( λ ) {T}_{i n } ( λ ) {R}_{B} ( λ )}{1 - {r}_{i} ( λ ) {R}_{B} ( λ )} \qquad ( 3 )$$

where R_{A} is the angular spectral reflectance at the angle θobs and T_{A} the angular spectral transmittance at the angle θobs of the transparency printed with the color A, R_{B} the spectral reflectance of the paper printed with the color B. It will be possible to refer in this regard to the publications cited hereinbelow. The bi-hemispherical spectral reflectance rᵢ of the transparency is defined as follows:

rₗ(λ)=∫₀_{ⱼ}₌₀^{π/2}R(θⱼ,λ)sin 2θⱼdθⱼ

where R(θⱼ,A) is the angular spectral reflectance at the angle gobs of the transparency for the angle of incidence θj and the wavelength λ. Likewise the bi-hemispherical spectral transmittance Tᵢₙ is written:

Tᵢₙ(λ)=∫_{θ}_{ⱼ}₌₀^{π/2}T(θⱼ,λ)sin 2θⱼdθⱼ

where T(θⱼ,λ) is the angular spectral transmittance at the angle gobs of the transparency for the angle of incidence θj and the wavelength λ.

An observation in transmission, at a given angle θobs, in diffuse lighting, leads to consideration of the superimposition of a transparency with a paper whose transmittance is given by:

$${T}_{ϕ ( A , B )} ( λ ) = \frac{{T}_{A} ( λ ) {T}_{i n} ( λ )}{1 - {r}_{i} ( λ ) {R}_{B} ( λ )}$$

where the parameters T_{A}(λ), Tᵢₙ(λ), rᵢ(λ) and R_{B}(λ) have the same meaning as in reflection mode.

In the case of the superimposition of N transparencies, it is possible to generalize the expression (2) for the transmittance by applying the following (wavelength-dependent) equation N−1 times, for j=2 to N and i=j−1:

$${T}_{1 … ij} ( {a}_{k} , {0}_{0} ) = \frac{{T}_{1 … i} ( {a}_{k} , {θ}_{0} ) {T}_{j} ( {a}_{k} , {θ}_{0} )}{1 - {R}_{i … 1} ( {a}_{k} , {θ}_{0} ) {R}_{j} ( {a}_{k} , {θ}_{0} )}$$

The equivalent of this equation for the verso of the stack is:

$${T}_{ji … 1} ( {a}_{k} , {θ}_{0} ) - \frac{{T}_{i … 1} ( {a}_{k} , {θ}_{0} ) {T}_{j} ( {a}_{k} , {θ}_{0} )}{1 - {R}_{i … 1} ( {a}_{k} , {θ}_{0} ) {R}_{j} ( {a}_{k} , {θ}_{0} )}$$

The equivalent for the reflectance on the recto of the stack is:

$${R}_{1 … ij} ( {a}_{k} , {θ}_{0} ) = {R}_{1 … i} ( {a}_{k} , {θ}_{0} ) + \frac{{T}_{1 … i}^{2} ( {a}_{k} , {θ}_{0} ) {R}_{j} ( {a}_{k} , {θ}_{0} )}{1 - {R}_{i … 1} ( {a}_{k} , {θ}_{0} ) {R}_{j} ( {a}_{k} , {θ}_{0} )}$$

and for the reflectance on the verso:

$${R}_{ji … 1} ( {a}_{k} , {θ}_{0} ) = {R}_{j} ( {a}_{k} , {θ}_{0} ) + \frac{{T}_{j}^{2} ( {a}_{k} , {θ}_{0} ) {R}_{i … 1} ( {θ}_{0} )}{1 - {R}_{i … 1} ( {a}_{k} , {θ}_{0} ) {R}_{j} ( {a}_{k} , {θ}_{0} )}$$

where θ₀ is the angle of observation, aₖ is the degree of coverage of the dye k and where the reflectances and transmittances depend on the wavelength.

As regards the models used, it is possible to refer to the following publications:
J. Machizaud and M. Hebert “Spectral reflectance and transmittance prediction model for stacked transparency and paper both printed with halftone colors”, JOSA A, Vol. 29, Number 8, pp. 1537-1548, July 2012,
J. Machizaud and M. Hebert, “Spectral transmittance model for stacks of transparencies printed with halftone colors”, volume 8292, pages 829212, Proc. SPIE, 2012,
M. Hébert and J. Machizaud, “Spectral reflectance and transmittance of stacks of nonscattering films printed with halftone colors”, JOSA A, Oct. 9, 2012 Doc. ID 171179,
M. Herbert and R. D. Hersch, “reflectance and transmittance model for recto-verso halftone prints: spectral predictions with multi-ink halftones”, JOSA A, Vol. 26 issue 2, pp. 35-364, February 2009, Each of these publications being incorporated here by reference.

It should be noted that the implementation of these models takes account of the composition and color of the supports used, of the composition and color of the inks used, of the printing process and if appropriate, of the algorithm for generating the halftones which constitute so many parameters for the determination of the decomposition color series which make it possible to obtain the target color in a given context of implementation.

Thus for diverse observation conditions (reflection, transmission) and diverse types of supports used (transparencies, paper, combination of the two), the spectrum of the light, therefore of the color, which arises from a superimposition of these halftone printed supports is predictable.

In one form of implementation of the invention involving a secret message, in order to construct a system of visual authenticators, the invention proposes to implement a secret image S which comprises at least one pattern, here the message m in itself, and a complementary region C namely the background. In the case of a binary secret image, FIG. 2, the message corresponds to the 1 bit and the background to the 0 bit or vice versa. The secret image is transformed by means of a visual cryptography algorithm into N shared color images on which, when they are taken individually, the secret image is not visible. The number N is greater than or equal to 2. According to the example illustrated in FIG. 3, N equals two and exactly two shared images P1 and P2 are generated in color.

According to the example illustrated, the secret image S comprises a message m which is able to be interpreted by the human visual system and which, in the present case, corresponds to a sequence of letters. The secret image S could also comprise a message which is able to be interpreted by a reading or artificial optical recognition system and which, for example, corresponds to a data-matrix. According to the invention, the secret image may comprise only a message intelligible to the human visual system or only a message intelligible to a reading or artificial optical recognition system. The secret image can also comprise a message intelligible both to the human visual system and to a reading or artificial optical recognition system, or a message intelligible to the human visual system and another message intelligible to a reading or artificial optical recognition system.

The construction of the system of visual authenticators can be carried out in the following manner, in the case of a system of authenticators with two shared images intended to be superimposed for the reading of the message m contained in the secret image.

Firstly, a target color is selected to be assigned for example to the 1 bit. Thereafter, there is undertaken the selection of a set of M series of decomposition colors making it possible to obtain, by superimposition, the target color. For this purpose use is made of the various previous models which make it possible to predict the spectrum of any paper or transparency printed in halftones, or else of a transparency superimposed on a paper, or else several stacked transparencies.

In the case where one of the two shared images is printed on a paper and the other on a transparency or else when the two shared images are each printed on a transparency, one and the same target color can be obtained on the basis of several combinations of decomposition colors printed on the various supports. To compare the target color and the colors obtained by superimposition, we use the CIELAB colorimetric distance ΔE₉₄ such as defined in the standard CIE116-1995—Industrial color difference evaluation. It will be considered that the target color is achieved when the distance of the color of the stack from the target color is less than the threshold of visual perception, that is to say typically when ΔE₉₄<1.

A process of searching for the colors to be printed on N transparencies observed at normal incidence in transmission to obtain the target color is the following. The corresponding spectral transmittance is denoted T_{target}(λ). Let us assume that this spectral transmittance can be obtained by superimposing N−1 virgin transparencies and a transparency printed with the nominal degrees of coverage cₚ, mₚ and yₚ for the cyan, magenta and yellow inks. We seek to reproduce T_{target}(λ), or at least to find a metameric spectral transmittance under a given illuminant. Accordingly, a first procedure consists in testing the set of degrees of coverage cᵢ, mᵢ and yᵢ associated with the three inks for each transparency i. At the first iteration of this procedure, the degree of coverage of each ink is incremented one after the other on the first transparency, while fixing the degrees of coverage of the inks on the other transparencies. Thereafter we calculate the spectral transmittance of the stack and calculate its ΔE₉₄ with the target spectral transmittance. If it is less than 1, the nominal degrees of coverage of the inks on the various transparencies are preserved. Thereafter we test other degrees of coverage of the inks by incrementing them successively until the whole set of possible combinations has been tested. With a printing system with three inks and a frame capable of printing p degrees of coverage per ink, a total of p³^{^{N}} combinations is thus tested.

This procedure making it necessary to calculate all combinations demands a significant calculation time. However, by discarding absurd combinations, it is possible to considerably reduce the calculation time. It is assumed that the quantity of each ink deposited to predict T_{target}(λ) is close to the quantity of each ink deposited on the N transparencies of the tested combination. Thus,

$${\sum }_{i - 1}^{N} {c}_{i} \approx {c}_{p} {\sum }_{i - 1}^{N} {m}_{i} \approx {m}_{p} {\sum }_{i - 1}^{N} {y}_{i} \approx {y}_{p}$$

Moreover, it may be assumed that the degrees of coverage cᵢ, mᵢ and yᵢ may not be greater than cₚ, mₚ and yₚ respectively, without which the absorption would be too significant. Values of cᵢ, mᵢ and yᵢ are chosen arbitrarily for the first N−1 transparencies, satisfying the following constraints:

$$∀ i ∈ \{ 1 , … , N - 1 \} , {c}_{i} < {c}_{p} {m}_{i} < {m}_{p} {y}_{i} < {y}_{p} and$$

$${\sum }_{i - 1}^{N - 1} {c}_{i} \leq {c}_{p} {\sum }_{i - 1}^{N - 1} {m}_{i} \leq {m}_{p} {\sum }_{i - 1}^{N - 1} {y}_{i} \leq {y}_{p}$$

Thereafter, we determine an initial value of the degrees of coverage on the first N−1 transparencies, the degrees of coverage associated with the N^{th} transparencies:

$${c}_{N} = {c}_{p} - {\sum }_{1}^{N - 1} {c}_{i} \qquad {m}_{N} = {m}_{p} - {\sum }_{1}^{N - 1} {m}_{i} \qquad {y}_{N} = {y}_{p} - {\sum }_{1}^{N - 1} {y}_{i}$$

Finally, the values of c_{N}, m_{N} and y_{N} are varied in fine increments until a triplet of values is found such that the spectrum given by the model and T_{target}(λ) have a discrepancy ΔE₉₄<0.5, the value 0.5 is chosen rather than 1 for the following reason: if we carry out several combinations of superimposed colors all having a discrepancy of less than 0.5 of the target color, then they will all be contained in the CIELAB space in a ball of radius 1, thereby ensuring that the maximum distance between them is 1, therefore imperceptible.

In the case of the example, M=2 and N=2, a set E1 is therefore created which comprises two series S1=(C1,C2) and S2=(D1,D2) of two decomposition colors which make it possible by superimposition to achieve the target color. Furthermore, a set E2 is constructed which comprises two color series S3 and S4, the color of rank 1 of the series S3 being the color of rank 1 of the series S1 and the color of rank 1 of the series S4 being the color of rank 1 of the series S2 while the color of rank 2 of the series S3 is the color of rank 2 of the series S2 and the color of rank 2 of the series S4 is the color of rank 2 of the series S1. Therefore S3=(C1,D2) and S4=(D1,C2).

To share a 1-bit (1 data bit) respectively a 0-bit, a series of decomposition colors is chosen randomly in E1, respectively E2. Any solution is considered to be valid if the following conditions are satisfied:

1. to share a 1-bit, the series of decomposition colors S1 and S2 chosen randomly in E1 reproduce the target color E, and the color difference between the color obtained by superimposition and the target color is imperceptible: ΔE₉₄[E,φ(C1,C2)]<d₁ and ΔE₉₄[E,φ(D1,D2)]<d₁, where ΔE₉₄ is the distance between two colors in the CIELAB 1994 space,

2. to share a 0-bit, the series of colors S3 and S4 chosen randomly in E2 provide a color whose distance from the target color is ΔE₉₄[E,φ(C1,D2)]>d₀, and ΔE₉₄ [E,φ(D1,C2)]>d₀

3. for each shared image, the colors which code a 0 bit must be the same as those coding a 1 bit and their probabilities of occurrence must be identical.

The tolerance threshold d₁ is defined so that there is no visually perceptible colorimetric difference: the value of ΔE₉₄ is less than 1.

Conditions 1 and 2 are related to the contrast between the 1 and 0 bits of the message. This contrast determines the visibility of the message when the shared images P1 and P2 are superimposed. The threshold d₀ is defined such that the zones of the shared images coding the 0-bit, after superimposition, differ visually from the target color, the value of ΔE₉₄ being sizably larger than 1. Among the pairs which satisfy condition 1, we retain the “crossed” pairs which satisfy condition 2 where i, jεI, i≠j and I a set of indices. The choice of the crossed pairs is preferred, it is however not compulsory and in this case i=j (the complementary region is then affected by noise). The series of decomposition colors E2 can be written: E2={(Cᵢ⁽¹⁾, Cⱼ⁽²⁾) where i,j ε I, i≠j, s.t. ΔE₉₄[E,φ(Cᵢ⁽¹⁾, Cⱼ⁽²⁾)]>d₀}, thereby making it possible to obtain the series of decomposition colors Γ₁ with E2={(Cᵢ⁽¹⁾, Cⱼ⁽²⁾) where i ε I s.t. ΔE₉₄[E,φ(Cᵢ⁽¹⁾, Cᵢ⁽²⁾)]<d₁} where the exponents (1) and (2) refer to the index number of the shared image. The cardinals of the series of decomposition colors Γ₀ and Γ₁ which are denoted #Γ₀ and #Γ₁, then satisfy the following inequality:

2≦Γ₁≦#Γ₀≦#Γ₁(#Γ₁−1)

As regards the lower limit, on account of the construction of the series of decomposition colors, this bound equals 2. Increasing the value of d₀ eliminates color pairs whose superimposition gives a color similar to the target color E. Therefore, the cardinal of the series of decomposition colors E1, E2 decreases. In a probabilistic approach, condition 2 is more flexible, since the target color can also code a 0-bit. Condition 2 provides a construction of the two series of decomposition colors.

Condition 3 pertains to security. It indicates that no information on the message or the target color is visible if the shared images are taken separately.

An illustration of this scheme is given in FIG. 3. We have selected two colors light magenta and magenta which are printed on the first support, and two colors brown and light yellow printed on the second support. The 1-bits are coded by a light brown color (a desaturated red) which corresponds to the target color E (see cases 1,2 in FIG. 3). The acceptable color difference between the two realizations is defined at d₁=0.5. The 0-bits are revealed by light yellow (case 3) or by dark brown (case 4), these two colors being very distant from the target color. The color pairs (light magenta, brown) and (magenta, light yellow) constitute the series of decomposition colors E1 while the color pairs (magenta, brown) and (light magenta, light yellow) form the series of decomposition colors E2.

To summarize FIG. 3, the light magenta decomposition color superimposed on the brown decomposition coupler gives the target color, light brown, associated with the coding of the 1-bits (series of decomposition colors S1). The same target color is also obtained with the superimposition of the magenta decomposition color and of the light yellow decomposition color (series of decomposition colors S2).

The inversion of the composition colors to be superimposed provides the series of colors S3 and S4 coding for the 0-bits.

The construction of the shared images P1 and P2 is therefore carried out by randomly choosing for the 1 bits from among the series of decomposition colors S1 and S2 and for the 0 bits from among the series of colors S3 and S4. The two shared images P1 and P2 are thus obtained, one of which can be recorded by printing on a security element such as an official document DO and the other on a transparent control film F, as illustrated in FIG. 4, forming a control device. It will then be possible to verify the authenticity of the official document DO by superimposing the control film F this authenticity is confirmed if the target color and/or the secret image are viewed.

In a variant embodiment which no longer corresponds to secrecy sharing, the film F is incorporated into the official document DO and the verification is performed by folding the official document in such a way as to superimpose the shared image P2 of the film on the shared image P1 printed on a paper part of the security document.

According to the exemplary embodiments described previously the shared images make it possible to reveal a target color and a secret message. However, the implementation of a secret message is not necessary. Thus, according to the example of FIG. 5, the shared images are produced from a pattern here an “S” which is cut up into a finite number of zones. After selection of the target color and of the series of decomposition colors which can be the same as the series 1 and 2 of the previous example, the two shared images which each reproduce the pattern are constructed by covering each zone with a decomposition color of a series chosen in a random manner from among the two decomposition series, each decomposition color of the chosen series being associated with a given shared image.

In the same way, each shared image might not comprise any pattern properly speaking and consist of a simple plain patch or halftone print of a decomposition color of a decomposition color series making it possible to produce the target color by superimposition.

The invention extends to a security document including a security element, such as a passport, an identity card, a driver's license, an interactive playing or collecting card, a payment means, in particular a payment card, a banknote, a purchase slip or a voucher, a transport card, a loyalty card, an entitlement card or a subscription card.

A security document thus obtained therefore comprises at least one security element such as described hereinabove. It may however comprise other “first level” security elements and/or at least one so-called “second level” and/or “third level” security element.

The document may in particular comprise the following security elements alone or in combination:
luminescent dyes and/or pigments and/or interferential pigments and/or liquid-crystal pigments, in particular in printed form or mixed with at least one constituent layer of the document,
photochromic or thermochromic components, dyes and/or pigments, in particular in printed form or mixed with at least one constituent layer of the document,
an ultraviolet (UV) absorber, in particular in coated form or mixed with at least one constituent layer of the document,
a specific light collecting material, for example of the “waveguide” type, for example a luminescent light collecting material such as polycarbonate-based polymer films marketed by the company BAYER under the name LISA®,
an interferential multilayer film,
a structure or a layer with variable optical effects based on interferential pigments or liquid crystals,
a birefringent or polarizing layer,
a diffraction structure,
an embossed image,
means producing a “moiré effect”, such an effect being able for example to reveal a pattern produced by the superimposition of two security elements on the document, for example bringing lines of two security elements closer together,
a partially reflecting refractive element,
a transparent lenticular grid,
a lens, for example a magnifying glass,
a colored filter,
another metallized, goniochromatic or holographic foil,
a layer with variable optical effect based on interferential pigments or liquid crystals,
a flat security element of relatively small format such as a flake, visible or non-visible, in particular luminescent, with or without electronic device,
particles or agglomerates of particles of pigments or dyes of HI-LITE type, visible or non-visible, in particular luminescent,
security fibers, in particular metallic, magnetic (with soft and/or hard magnetism), or absorbent, or excitable with ultraviolet, with visible or with infrared, and in particular the near infrared (NIR),
an automatically readable security having specific and measurable characteristics of luminescence (for example fluorescence, phosphorescence), absorbtion of light (for example ultraviolet, visible or infrared), Raman activity, magnetism, microwave interaction, interaction with X-rays or electrical conductivity,
unfalsification reagents, for example dipyridyl with ferric ions which, during attempted falsification with a reducing agent, are reduced to ferrous ions and reveal a red color,
a reagent such as potassium iodate able to form a visible, colored mark during attempted falsification,
one or more security elements such as defined above may be present in the document and/or in one or more constituent layers of the document or in one or more security elements incorporated into the document and/or into one or more constituent layers of the document, such as for example a security thread, a fiber or a flake.

According to the examples described previously the determination of the series of decomposition colors involves a printing of the shared images, however according to the invention this determination can also be done by simple calculation without shared image printing.

Moreover, according to the examples described the recording of the shared images is performed by printing on a support, however such a mode of recording is not strictly necessary for the implementation of the invention.

Thus, according to one mode of implementation of the invention and, for example, in the case of the implementation of two shared images one of the images is recorded on a transparent or translucent support for example by printing while the other is recorded in electronic form. During the verification phase, the shared image recorded in electronic form is displayed on a screen and the support bearing the other shared image is placed on the screen in such a way as to superimpose the two shared images and to view the result of this superimposition.

According to another mode of implementation, the shared image recorded in electronic form is projected by means of a video projector on the shared image recorded on a support in such a way as to superimpose the two shared images and to view the result of this superimposition.

In the same way, the shared images may be recorded in an electronic form and form the subject of a superimposition by means of a display device displaying them simultaneously such as a screen and/or a video projector.

Of course, diverse other modifications or variants may be envisaged within the framework of the appended claims.

1. A method for authenticating a security element by superimposing N shared color images so as to obtain at least one target color, said method comprising a phase of constructing an authenticator system comprising at least:
a step of selecting a target color,
a step of selecting a series of N decomposition colors which, by superimposition, together make it possible to obtain the target color,
a step of recording the N shared images each with a decomposition color of the series.

2. The method of authentication as claimed in claim 1, wherein the construction phase comprises:
a step of selecting at least one pattern cut up into a finite number of zones,
a step of selecting a target color per zone,
a step of selecting for each target color a set of M series of N decomposition colors, the decomposition colors of each series making it possible, by superimposition, together to obtain said target color,
a step of constructing N shared images each one reproducing each pattern, the construction step involving for each zone of a pattern:
the choosing of a series of N decomposition colors from the selected set,
the assigning to said zone and for each shared image of a decomposition color of the chosen series, and
a step of recording the N shared images.

3. The method of authentication as claimed in claim 2, wherein the choosing of the series of N decomposition colors is performed in a random or pseudo-random manner from the selected set.

4. The method of authentication as claimed in claim 1, wherein each decomposition color of the series associated with a target color is used, for a given zone, on a single shared image.

5. The method of authentication as claimed in claim 1, wherein the construction phase comprises:
a step of selecting a secret image which comprises at least one pattern and a region complementary to the pattern, each cut up into a finite number of zones,
a step of selecting a target color associated with each zone,
a step of selecting, for each target color, a set of M series of N decomposition colors, the decomposition colors of each series making it possible, by superimposition, together to obtain the target color and M being greater than or equal to 2,
a step of constructing N shared images such that:
for each zone of each pattern, a series of decomposition colors is chosen from the selected set of M series of N decomposition colors for the target color of said zone, the decomposition color of rank k in said series is assigned to the zone in the shared image of rank k in the superimposition of the N shared images,
for each zone of the complementary region, a decomposition color of rank k is chosen from among the decomposition colors of like rank in the selected set of M series of N decomposition colors, and
a step of recording the N shared images.

6. The method of authentication as claimed in claim 5, wherein for each zone of the complementary region a decomposition color of rank k is chosen from among the decomposition colors of like rank in the selected set of M series of N decomposition colors so that the N decomposition colors chosen do not together give, by superimposition, the target color.

7. The method of authentication as claimed in claim 5, wherein the secret image is visible in transmitted light and is not visible in reflected light.

8. The method of authentication as claimed in claim 5, wherein the choosing of the series of N decomposition colors for each pattern zone and/or the choosing of the decomposition colors for each complementary region zone are performed in a random or pseudo-random manner.

9. The method of authentication as claimed in claim 3, wherein each random choice is performed by means of at least one random sequence, the so-called brand signature, which is extracted or generated on the basis of at least one structural characteristic of a region at least of the security element and is able to be generated or extracted on demand and obtained identically or quasi-identically on the basis of the security element.

10. The method of authentication as claimed in claim 1, wherein the decomposition colors are recorded as halftones.

11. The method of authentication as claimed in claim 1, wherein for each decomposition series the target color is obtained in a predefined order of superimposition.

12. The method of authentication as claimed in claim 1, wherein the number N is equal to 2 or 3.

13. The method of authentication as claimed in claim 1, wherein the number M is greater than or equal to 2 and, preferably, equals 2 or 3.

14. The method of authentication as claimed in claim 1, wherein the phase of constructing the authenticator system comprises a step of recording at least one of the shared images in digital form.

15. The method of authentication as claimed in claim 1, comprising a step of recording at least one of the shared images in printed form.

16. The method of authentication as claimed in claim 1, wherein the phase of constructing an authenticator system comprises a step of printing at least one of the shared images on the security element.

17. The method of authentication as claimed in claim 1, wherein at least one of the shared images is recorded by printing on a translucent support.

18. The method of authentication as claimed in claim 1, wherein at least one of the shared images is recorded by printing on a transparent support.

19. The method of authentication as claimed in claim 1, wherein all the shared images are recorded on an at least translucent support and in that, according to the order of stacking of the shared images, the color observed in reflection is different on the recto and on the verso of the stack.

20. The method of authentication as claimed in claim 1, wherein at least one of the shared images is recorded by printing on an opaque support.

21. The method of authentication as claimed in claim 1, wherein the phase of constructing an authenticator system comprises a step of recording in printed form at least one shared image and a step of recording at least one other shared image in digital form.

22. The method of authentication as claimed in claim 1, comprising a phase of verification by a user comprising:
a step of superimposing at least part of the shared images so as to allow viewing of at least one target color and optionally of a secret image.

23. The method of authentication as claimed in claim 1, wherein the shared images are superimposed in a predefined order.

24. The method of authentication as claimed in claim 1, wherein at least one presentation step is performed by means of an electronic display or projection device.

25. The method of authentication as claimed in claim 1, wherein at least one presentation step is performed by means of at least one printed shared image.

26. A method for verifying the authenticity of a security element bearing at least one first shared image constructed in accordance with the method of authentication as claimed in claim 1, said method of verification comprising the following steps:
implementation of the security element,
implementation of at least one other shared image,
superimposition of the shared images,
verification that the viewed target color and/or the viewed secret image corresponds to the target color and/or to the secret image expected so as in the affirmative to conclude the authenticity of the security element.

27. The method of verification as claimed in claim 26, comprising:
a step of observation in reflected light of the recto and of the verso of the superimposition of the shared images and verification that the target color observed on the recto is different from the target color observed on the verso so as in the affirmative to conclude the authenticity of the security element.

28. The method of verification as claimed in claim 26, wherein the shared images are superimposed in a predefined order.

29. A security element comprising at least one first shared image which is recorded in accordance with the method of authentication as claimed in claim 1 and which is intended to allow the obtaining of at least one target color and/or of a secret image superimposed with at least one other shared image recorded in accordance with the method of authentication as claimed in claim 1.

30. The security element as claimed in claim 29, comprising at least two shared images recorded in accordance with the method of authentication as claimed in claim 1.

31. The security element as claimed in claim 29, wherein the security element is adapted for allowing the superimposition of the shared images that it bears.

32. The security element as claimed in claim 29, comprising at least one semi-reflecting layer which covers in part at least one shared image and which is transparent according to one angle of observation and reflects light according to another angle of observation.

33. The security element as claimed in claim 29, wherein each shared image of the security element is recorded as halftones.

34. A security document including the security element as claimed in claim 29, the security document being at least one of a passport, an identity card, a driver's license, an interactive playing or collecting card, a payment means, in particular a payment card, a banknote, a purchase slip or a voucher, a secure label, a transport card, a loyalty card, an entitlement card or a subscription card.
